(19) United States
(12) Patent Application Publication
(10) Pub. No.: US 2013/0132286 A1
(43) Pub. Date: May 23, 2013

(54) METHOD AND SYSTEMS FOR SERVICING A SUBSCRIBER VEHICLE

(71) Applicants: Mark S. Schaefer, Colorado Springs, CO (US); Michael B. Ames, Lake Orion, MI (US)

(72) Inventors: Mark S. Schaefer, Colorado Springs, CO (US); Michael B. Ames, Lake Orion, MI (US)

(73) Assignee: GENERAL MOTORS LLC, DETROIT, MI (US)

(21) Appl. No.: 13/298,963

(22) Filed: Nov. 17, 2011

(51) Int. Cl. H04W 4/04; G06Q 10/00

(52) U.S. Cl. 705/305; 370/310

(57) ABSTRACT

A method for servicing a subscriber vehicle involves establishing a connection, via a telematics unit, with a communications device at a third party facility. A packet data message is sent from the telematics unit to a telematics service center. The packet data message includes identification information of the vehicle, and is sent using an internet protocol address of the third party facility. Via a processor associated with the telematics service center, the subscriber vehicle is identified from the identification information, and the third party facility is identified from the internet protocol address. A notification message is sent from the telematics service center to the third party facility, where the message indicates that the subscriber vehicle is available for servicing. Also disclosed herein are systems for accomplishing the same.

### TECHNICAL FIELD

The present disclosure relates generally to methods and systems for providing services to a subscriber vehicle.

### BACKGROUND

Various commercial establishments are designed to provide services to consumer vehicles, and sometimes these services are provided in exchange for payment. Short range wireless communication technologies have been utilized to perform some commercial transactions with customer vehicles. One example of this technology includes a smart card that may be used to render a payment by waving the card near a card reader. Another example includes a key fob device programmed with credit or debit information, and this programmed key fob may be waved near a reader to render a payment. Despite the usefulness of these technologies, methods and/or systems for performing commercial transactions that are quicker and require less work on behalf of the consumer and/or the retailer may be desirable.

### SUMMARY

A method for servicing a subscriber vehicle is disclosed herein. The method involves, via a telematics unit of the subscriber vehicle, establishing a connection with a communications device at a third party facility. A packet data message is sent from the telematics unit to a telematics service center. The packet data message includes identification information of the subscriber vehicle, and is sent using an internet protocol address of the third party facility. Via a processor operatively associated with the telematics service center, the subscriber vehicle is identified from the identification information, and the third party facility is identified from the internet protocol address. The method further includes sending a notification message from the telematics service center to the third party facility, where the notification message indicates that the subscriber vehicle is available for servicing.

Also disclosed herein are systems for servicing a subscriber vehicle.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for providing services to a subscriber vehicle;

FIG. 2 is a schematic diagram depicting another example of a system for providing services to a subscriber vehicle;

FIG. 3 is a flow diagram depicting an example of a method for providing services to a subscriber vehicle;

FIG. 4 schematically depicts an example of a third party facility, where a plurality of vehicles are waiting for service in a drive thru line;

FIG. 4A schematically depicts another example of the third party facility of FIG. 4; and

FIG. 5 schematically depicts another example of a third party facility, where a plurality of vehicles are either located in, or entering a parking lot of the third party facility.

### DETAILED DESCRIPTION

Example(s) of the method and systems, as disclosed herein, may be used to provide goods and/or services to a subscriber vehicle. In some instances, the goods and/or services are part of one or more commercial transactions that occur between a third party facility and the subscriber vehicle. In other instances, the goods and/or services are free of charge; i.e., no payment is required upon receiving the goods and/or services. Examples of goods that are free of charge include any tangible item or item that can become tangible (e.g., printed) that is available by the third party facility and that is provided to the vehicle without payment (e.g., coupons). Examples of services that are free of charge may include advertisements, information solicited by the vehicle, and/or the like.

It is believed that goods and/or services may be effectively and efficiently provided to subscriber vehicles via the method and systems of the instant disclosure. For instance, a subscriber vehicle may establish a wireless connection with a communications device at the third party facility, and through this connection, send vehicle information to a back office of a telematics service provider using an internet protocol address of the third party facility. The back office utilizes the vehicle information to identify the vehicle, and the internet protocol address to identify the third party facility. With such identification information, the back office notifies the third party facility that the vehicle is waiting for service, and may, in some instances, provide information that may be usable by the third party facility to effectively and efficiently service the vehicle. The information provided to the third party facility may include the make, model, year, and/or color of the vehicle waiting for service, and perhaps any preferences pertaining to how the vehicle is to be serviced. In some instances, the back office also provides payment information to the third party facility, which may be used to pay for the goods/services rendered to the subscriber vehicle. Other advantages of the instant disclosure will be evident from the description of the various examples of the method and systems set forth below.

It is to be understood that, as used herein, the term “user” includes a vehicle owner, a vehicle driver, and/or a vehicle passenger. In instances where the user is the vehicle owner, the term “user” may be used interchangeably with the terms subscriber and/or service subscriber.

The term “communication” is to be construed to include all forms of communication, including direct and indirect communication. Indirect communication may include communication between two components with additional component(s) located therebetween.

Further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

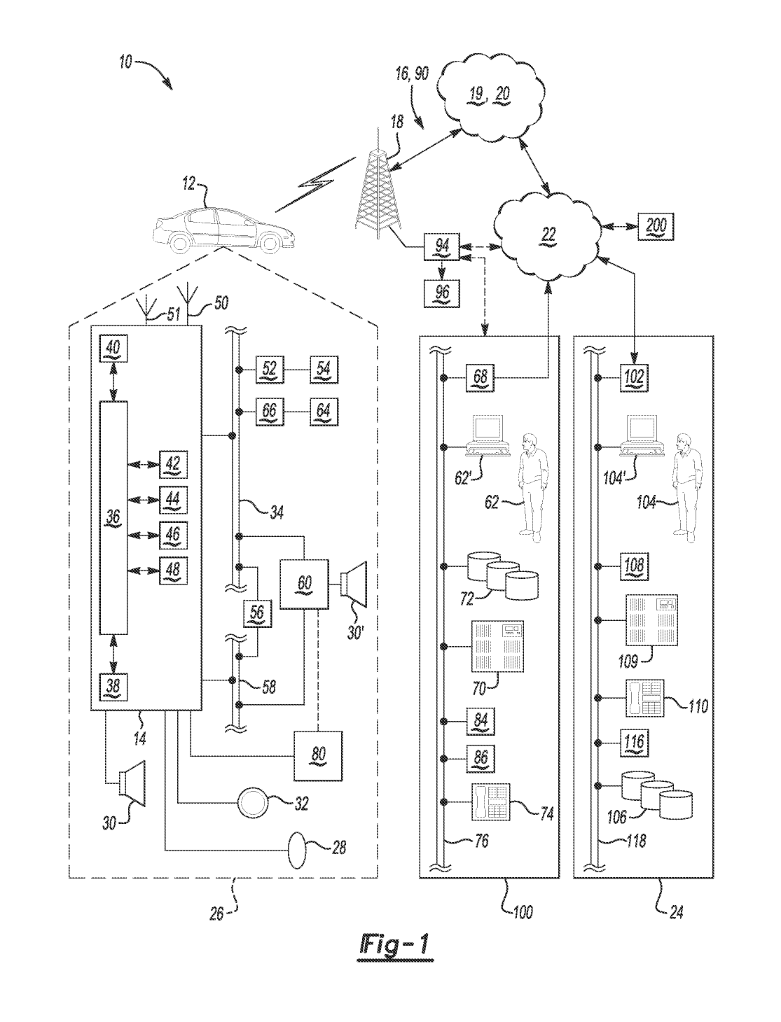

Referring now to FIG. 1, an example of a system 10 for servicing a subscriber vehicle includes the vehicle 12, a carrier/communication system 16 (including, but not limited to, one or more cell towers 18, one or more base stations 19 and/or mobile switching centers (MSCs) 20, and one or more service providers (e.g., 90) including mobile network operator(s)), one or more land networks 22, one or more data centers 100, one or more application centers 24 (which may also be referred to as an application specific call center), and one or more third party facilities 200. In an example, the carrier/communication system 16 is a two-way radio frequency communication system, and may be configured with a web service supporting system-to-system communications (e.g., communications between a telematics application center 24 and the service provider 90).

The wireless carrier/communication system 16 also includes a host server 94 including suitable computer equipment (not shown) upon which information of a remotely accessible page 96 resides/is stored. For instance, the remotely accessible page 96 is a webpage set up and maintained by a telematics service provider, and the user may access the page 96 by, e.g., submitting personal information (e.g., a login ID) and authenticating information (e.g., a password, a PIN, etc.). The computer equipment used to log into the page 96 may also include hardware which, for example, can receive and read a smart card for identification/authentication purposes, or can utilize biometrics for identification/authentication purposes.

The overall architecture, setup and operation, as well as many of the individual components of the system 10 shown in FIG. 1 are generally known in the art. Thus, the following paragraphs provide a brief overview of one example of the system 10. It is to be understood, however, that additional components and/or other systems not shown here could employ the method(s) disclosed herein.

Vehicle 12 may be a mobile land vehicle (such as a motorcycle, car, truck, recreational vehicle (RV), or the like), a water vehicle (such as a boat) or an air vehicle (such as a plane, helicopter, or the like), and the vehicle 12 is equipped with suitable hardware and software that enables it to communicate (e.g., transmit and/or receive voice and data communications) over the carrier/communication system 16.

Some of the vehicle hardware 26 is generally shown in FIG. 1, including the telematics unit 14 and other components that are operatively connected to the telematics unit 14. Examples of other hardware 26 components include a microphone 28, speakers 30, 30′ and buttons, knobs, switches, keyboards, and/or controls 32. Generally, these hardware 26 components enable a user to communicate with the telematics unit 14 and any other system 10 components in communication with the telematics unit 14. It is to be understood that the vehicle 12 may also include additional components suitable for use in, or in connection with, the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections, such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard vehicle dedicated communications device. In an example, the telematics unit 14 is linked to the telematics service center (e.g., the data center(s) 100 and the application center(s) 24) via the carrier system 16, and is capable of calling and transmitting data to the telematics data center(s) 100 and/or the application center(s) 24.

The telematics unit 14 provides a variety of services, both individually and through its communication with a telematics application center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit or a unit enabled with WiFi™), a dual antenna 50, and a short range wireless antenna 51. In one example, the wireless modem 42 includes a computer program and/or set of software routines (i.e., computer readable instructions embedded on a non-transitory, tangible medium) executing within processing device 36.

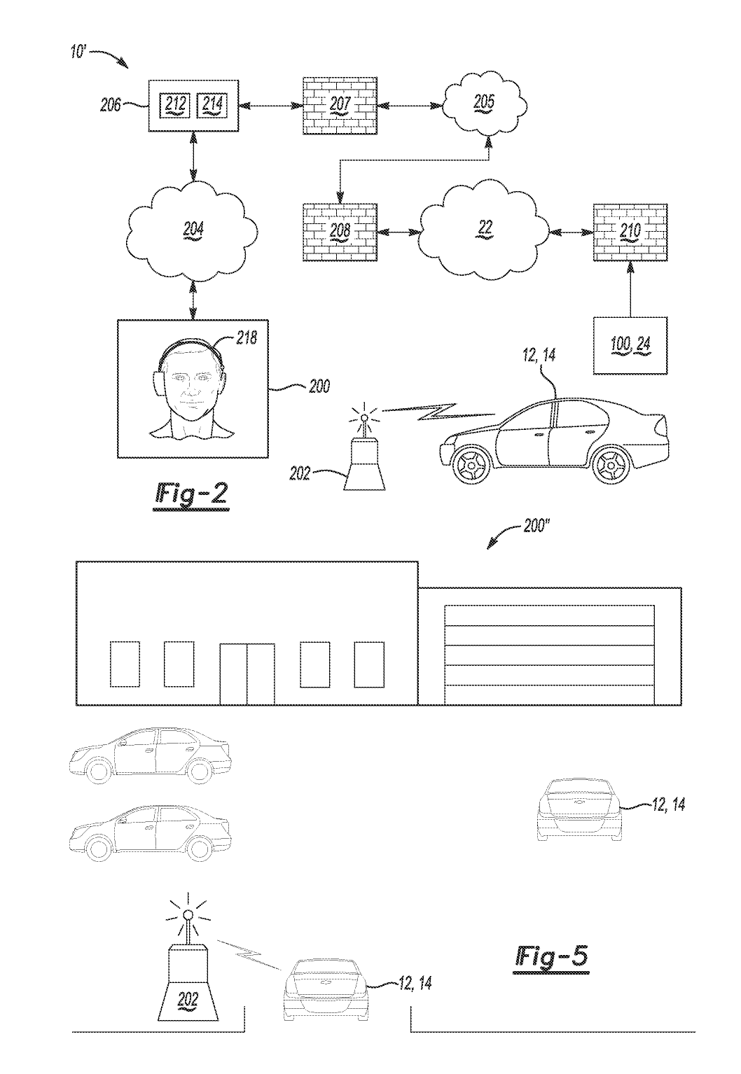

The short range wireless communication unit 48 may be used to establish a BLUETOOTH® connection between the telematics unit 14 and another communications device, or if configured with Wi-Fi™ connectivity, may be used to establish a Wi-Fi™ connection between the telematics unit 14 and another communications device. The other communications device may be, e.g., a communications device 202 at a third party facility 200 as shown in FIG. 2. In one example, the device 202 is a wireless access point (WAP), which allows wireless devices (e.g., the telematics unit 14) to connect to a wired network using BLUETOOTH®, Wi-Fi™ or other related standards. The telematics unit 14 may connect with the device 202/WAP when the telematics unit 14 is within a wireless connection range of the device 202. The third party facility 200 and the communications device 202 will be described below in further detail in conjunction with FIG. 2.

It is to be understood that the telematics unit 14 may be implemented without one or more of the above listed components (e.g., the real time clock 46), except in some examples disclosed herein, the telematics unit 14 includes the short range wireless network 48. It is to be further understood that telematics unit 14 may also include additional components and functionality as desired for a particular end use.

The electronic processing device 36 of the telematics unit 14 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor. The electronic processing device 36 (also referred to herein as a processor) may, for example, include software programs having computer readable code to initiate and/or perform various functions of the telematics unit 14, as well as computer readable code for performing various steps of the examples of the method disclosed herein. The computer readable codes of the software programs run by the processor 36 contain computer readable instructions embedded on a non-transitory, tangible medium.

Still referring to FIG. 1, the location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown). In an example, the location detection chipset/component 44 may provide then-current GPS location data of the vehicle 12, which may be transmitted to the telematics service center as vehicle data in response to a request for such data.

The cellular chipset/component 40 may be an analog, digital, dual-mode, dual-band, multi-mode and/or multi-band cellular phone. Basically, the cellular chipset 40 is a semiconductor engine that enables the telematics unit 14 to connect with other devices (e.g., other mobile communications devices) using some suitable type of wireless technology. The cellular chipset-component 40 uses one or more prescribed frequencies in the 800 MHz analog band or in the 800 MHz, 900 MHz, 1900 MHz and higher digital cellular bands. In some cases, the cellular chipset/component 40 may also use a frequency below 800 MHz, such as 700 MHz or lower. In yet other cases, the cellular chipset/component 40 may use a frequency above 2600 MHz. Any suitable protocol may be used, including digital transmission technologies, such as TDMA (time division multiple access), CDMA (code division multiple access), GSM (global system for mobile telecommunications), and LTE (long term evolution). In some instances, the protocol may be short range wireless communication technologies, such as BLUETOOTH®, dedicated short range communications (DSRC), or Wi-Fi™. In other instances, the protocol is Evolution Data Optimized (EVDO) Rev B (3G) or Long Term Evolution (LTE) (4G). In an example, the cellular chipset/component 40 may be used in addition to other components of the telematics unit 14 to establish communications between the vehicle 12 and another party.

Also associated with electronic processing device 36 is the previously mentioned real time clock (RTC) 46, which provides accurate date and time information to the telematics unit 14 hardware and software components that may require and/or request date and time information. In an example, the RTC 46 may provide date and time information periodically, such as, for example, every ten milliseconds.

The electronic memory 38 of the telematics unit 14 may be configured to store data associated with the various systems of the vehicle 12 (i.e., vehicle data), vehicle operations, vehicle user preferences and/or personal information, and the like. In an example, the electronic memory 38 also stores an access point identifier (also referred to as service set identifier (SSID)), which is a previously approved identifier that the vehicle 12 may use to establish short range wireless connections with a device 202/WAP. In an example, the vehicle 12 may use the SSID as an identifier to establish a wireless connection between the telematics unit 14 and the communications device 202/WAP located at the third party facility 200 (shown in FIG. 2). In one example, the communications device 202 is configured with Wi-Fi™ technology so that the telematics unit 14 can wirelessly connect with the device 202. Further, the WAP (which may be known as a hotspot for Wi-Fi™ connections) may have a preset wireless access range for Wi-Fi™ connections, or may have a standard range of about 20 meters (i.e., about 65 feet) indoors, and a larger range outdoors. When the communications device 202/WAP is configured for BLUETOOTH® connections, the WAP may have a preset wireless access range, or may have a standard range of about 10 meters (i.e., about 32 feet).

In some cases, the electronic memory 38 may contain a set of previously approved SSIDs that may enable the vehicle 12 to establish wireless connections with a number of different WAPs. In other words, the electronic memory 38 may have stored therein a plurality of SSIDs; each giving the telematics unit 14 permission to access respective wireless access points 202 located at various third party facilities 200. For instance, three SSIDs may be stored in the memory 38; where one SSID provides the telematics unit 14 with access to a wireless access point 202 at store A on 12^{th} Street, another SSID provides the telematics unit 14 with access to a wireless access point 202 at store B on ABC Avenue, and yet another SSID provides the telematics unit 14 with access to a wireless access point at restaurant C on Shady Lane. The access point identifiers may be pre-programmed into the telematics unit 14 (i.e., stored in the memory 38) at the time of manufacture, or by a dealership upon purchasing the vehicle 12. The access point identifiers may otherwise be programmed into the telematics unit 14 over the air (e.g., downloaded using component(s) of system 16) at a later time.

While the access point identifier provides the telematics unit 14 with access to a particular device 202/WAP, the telematics unit 14 may utilize a pre-shared wireless connection key to establish a short range wireless connection with the device 202. The wireless connection key may be a security code of the telematics unit 14 that is generated during pairing (e.g., a BLUETOOTH® pairing) of the telematics unit 14 and the device 202. The key may also be used by the telematics unit 14 to establish its identity and authenticity for communications with the third party facility 200 at which the device 202 is located. It is to be understood that the communications device 202 also generates its own wireless connection key, and the devices 14, 202 are considered to be paired when the devices 14, 202 exchange their respective wireless connection keys. After an initial BLUETOOTH® pairing is made, it is to be understood that authentication of the vehicle 12 may take place before the telematics service provider will contact the third party facility 200 about the presence of the vehicle 12. Further details of the pairing of the two devices 14, 202 will be described below.

The telematics unit 14 provides numerous services alone or in conjunction with the telematics service center (e.g., the data center 100 and/or the application center 24), some of which may not be listed herein, and is configured to fulfill one or more user or subscriber requests. Several examples of these services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering. It is to be understood that when these services are obtained from the telematics service center, the telematics unit 14 is considered to be operating in a telematics service mode.

Vehicle communications generally utilize radio transmissions to establish a voice channel with carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. In one example, an Evolution Data Optimized (EVDO) Rev B (3G) system (which offers a data rate of about 14.7 Mbit/s) or a Long Term Evolution (LTE) (4G) system (which offers a data rate of up to about 1 Gbit/s) may be used. These systems permit the transmission of both voice and data simultaneously. Generally, dual mode antenna 50 services the location detection chipset/component 44 and the cellular chipset/component 40.

The microphone 28 provides the user with a means for inputting verbal or other auditory commands (e.g., requests for goods and/or services from the third party facility 200, etc.), and can be equipped with an embedded voice processing unit utilizing human/machine interface (HMI) technology known in the art. Conversely, speaker(s) 30, 30′ provide verbal output to the vehicle occupants and can be either a stand-alone speaker 30 specifically dedicated for use with the telematics unit 14 or can be part of a vehicle audio component 60, such as speaker 30′. In either event and as previously mentioned, microphone 28 and speaker(s) 30, 30′ enable vehicle hardware 26 and the data center 100 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the data center 100 (whether it be a live advisor 62 or an automated call response system 62′) or the application center 24 (whether it be a live advisor 104 or an automated call response system 104′) to request services, to initiate a voice call to another mobile communications device, etc.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system (e.g., speaker 30′), or may utilize speaker 30 via arbitration on vehicle bus 34 and/or audio bus 58.

Still referring to FIG. 1, the vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, speed sensors, magnetometers, emission detection and/or control sensors, environmental detection sensors, and/or the like. One or more of the sensors 64 enumerated above may be used to obtain the vehicle data mentioned above. Example sensor interface modules 66 include powertrain control, climate control, body control, and/or the like.

The vehicle hardware 26 includes the display 80, which may be operatively directly connected to or in communication with the telematics unit 14, or may be part of the audio component 60. The display 80 may be any human-machine interface (HMI) disposed within the vehicle 12 that includes audio, visual, haptic, etc. The display 80 may, in some instances, be controlled by or in network communication with the audio component 60, or may be independent of the audio component 60. Examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

As mentioned above, the system 10 includes the carrier/communication system 16. A portion of the carrier/communication system 16 may be a cellular telephone system or any other suitable wireless system that transmits signals between the vehicle hardware 26 and land network 22. According to an example, the wireless portion of the carrier/communication system 16 includes one or more cell towers 18, base stations 19 and/or mobile switching centers (MSCs) 20, as well as any other networking components required to connect the wireless portion of the system 16 with land network 22. It is to be understood that various cell tower/base station/MSC arrangements are possible and could be used with the wireless portion of the system 16. For example, a base station 19 and a cell tower 18 may be co-located at the same site or they could be remotely located, or a single base station 19 may be coupled to various cell towers 18, or various base stations 19 could be coupled with a single MSC 20. A speech codec or vocoder may also be incorporated in one or more of the base stations 19, but depending on the particular architecture of the wireless portion of the system 16, it could be incorporated within an MSC 20 or some other network components as well.

Land network 22 may be a conventional land-based telecommunications network that is connected to one or more landline telephones and connects the wireless portion of the carrier/communication network 16 to the telematics data center 100 and/or application center 24. For example, land network 22 may include a public switched telephone network (PSTN) and/or an Internet protocol (IP) network. It is to be understood that one or more segments of the land network 22 may be implemented in the form of a standard wired network, a fiber or other optical network, a cable network, other wireless networks, such as wireless local networks (WLANs) or networks providing broadband wireless access (BWA), or any combination thereof. Communications between i) the vehicle 12 and the telematics service center (24 and/or 100) and/or ii) the third party facility 200 and the telematics service center (24 and/or 100) may be established through the land network 22.

Data center 100 is designed to provide the vehicle hardware 26 with a number of different system back-end functions. Generally, the data center 100 receives voice and/or data calls, analyzes requests associated with the voice or data calls, and, in some cases, transfers the calls to an application specific call/service center (such as the application center 24 shown in FIG. 1, which will be described in detail below). The data center 100 is also in selective and operative communication with the application center 24 via the wireless carrier/communication system 16 or via a wired connection. Additionally, for purposes of the instant disclosure, the data center 100 is in selective and operative communication with the third party facility 200. Referring briefly to FIG. 2, the data center 100 and third party facility 200 may be connected via a server 206 that is operatively associated with both the third party facility and the telematics service provider. The server 206 may be owned by the third party facility 200 or the telematics service provider. The data center 100 is configured to provide information to the third party facility 200 regarding the vehicle 12, preferences, etc. As such, the data center 100 is configured to receive data connections from the server 206, and to initiate data connections with the server 206.

According to the example shown here, the data center 100 generally includes one or more switches 68, servers 70, databases 72, live and/or automated advisors 62, 62′, processing equipment (or processor) 84, a communications module 86, as well as a variety of other telecommunication and computer equipment 74 that is known to those skilled in the art. These various telematics service provider components are coupled to one another via a network connection or bus 76, such as one similar to the vehicle bus 34 previously described in connection with the vehicle hardware 26.

The processor 84, which is often used in conjunction with the computer equipment 74, is generally equipped with suitable software and/or programs enabling the processor 84 to accomplish a variety of data center 100 functions. Further, the various operations of the data center 100 are carried out by one or more computers (e.g., computer equipment 74) programmed to carry out some of the tasks of the data center 100. The computer equipment 74 (including computers) may include a network of servers (including server 70) coupled to both locally stored and remote databases (e.g., database 72) of any information processed.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72.

The application center 24 may be a dedicated facility for managing and handling transmissions related to particular services, such as emergency services, navigation services, third party facility transaction services, etc. In an example, the application center 24 is a third party facility transaction services application center. In this example, upon receiving packet data from the telematics unit 14, the switch 68 at the data center 100 routes the packet data to the switchboard 102 at the third party transaction services application center 24 (which may also be a website application center including a third party facility transaction services division), and then the packet data is routed by the switchboard 102 to, e.g., a processor 108. The processor 108 analyzes the data in the transmission, and retrieves appropriate information contained in a user profile stored in one of the databases 106 at the application center 24. This information may ultimately be transmitted to the third party facility 200 (e.g., to the server 206 associated with the third party facility 200) for use in providing service(s) to the vehicle 12.

Referring back to the description of the data center 100, the database(s) 72 may be designed to store subscriber profile records, subscriber behavioral patterns, or any other pertinent subscriber information. In an example, the database(s) 72 may be configured to store the user profile mentioned above, which may contain personal information of the subscriber (e.g., the subscriber's name, garage address, billing address, home phone number, cellular phone number, etc.), as well as subscriber selected preferences (e.g., restrictions on certain services that may be provided to the vehicle 12, favorites related to a particular service, etc.). All or selected portions of the user profile may be transmitted from the data center 100 to the third party facility 200 (i.e., to the server 206) when services are desired by the vehicle 12, and such information contained in the user profile may be used to assist with servicing the vehicle 12.

It is to be understood that the databases 72 may allow the data center 100 to function as a repository for data collected from the telematics unit 14 and/or from the application center 24. In some instances, another facility may function as a repository for collected data (e.g., a lab (not shown) associated with the application center 24 and/or the data center 100).

The communications module 86 at the data center 100 is configured, via suitable communications equipment (such as equipment capable of handling messaging between the data center 100 and the telematics unit 14 (e.g., switches, switchboards, etc.), modems (e.g., a wireless modem similar to modem 42), TCP/IP supporting equipment, and/or the like), to enable the data center 100 to establish a communication with, for example, the telematics unit 14, or visa versa. The communications module 86 is also configured to enable the data center 100 to establish a communication with the third party facility 200. In an example, the communications module 86 receives packet data from the telematics unit 14, and the packet data may include, for instance, vehicle data representing a then-current location of the subscriber vehicle 12 that is within proximity of the third party facility 200, and data indicating that the vehicle 12 is available for servicing. Upon receiving the packet data, the communications module 86 unpacketizes the data. The communications module 86 identifies that the data pertains to a particular subscriber vehicle 12 and that the vehicle 12 will be requesting services from the third party facility 200, and then transmits the data to, e.g., the processor 84. The processor 84 may run computer readable code/software routines that can receive the data and determine what information should be sent back to the third party facility 200 so that the facility 200 can use the information to effectively and efficiently service the vehicle 12. In some instances, the communications module 86 may also transmit, for example, credentials necessary for the third party facility 200 to directly connect with the vehicle 12.

It is to be appreciated that the data center 100 may be any central or remote facility, manned or unmanned, mobile or fixed, to or from which it is desirable to exchange voice and data communications. As such, the live advisor 62 may be physically present at the data center 100 or may be located remote from the data center 100 while communicating therethrough.

As mentioned above, the application center 24, which is in selective and operative communication with the data center 100, is a dedicated facility for addressing specific requests, needs, or the like of the user, the data center 100, the third party facility 200, or combinations thereof. In an example, several application centers 24 may be associated with the data center 100, where each application center is designed to address the specific request, need, etc. Examples of the application centers 24 include emergency service centers, navigation route centers, third party facility service centers, or the like.

As shown in FIG. 1, the application center 24 may include the switchboard 102, databases 106, live and/or automated advisors 104, 104′, the processor 108, a server 109, as well as a variety of other telecommunication and computer equipment 110 that is known to those skilled in the art. In some instances, the application center 24 may also include various modules, such as communications module 116. In these instances, the modules at the application center 24 may be used to perform the functions described above for the module 86 at the data center 100. These various application center components are coupled to one another via a network connection or bus 118, such as one similar to the vehicle bus 34 or the data center bus 76 described above.

Switchboard 102, which may be a private branch exchange (PBX) switch, routes incoming signals so that voice transmissions (e.g., voice calls) are usually sent to either the live advisor 104 or the automated response system 104′, and data transmissions (e.g., packetized voice communications) are passed on to a modem or other piece of equipment (not shown) for demodulation and further signal processing. The modem preferably includes an encoder, as previously explained, and can be connected to various devices such as the server 109 and database 106.

The database(s) 106 may be designed to store a variety of information usable by the application center 24. When the application center 24 is a navigation route service center, the database(s) 106 may store various routes and/or points of interest often requested by a particular user. When the application center 24 is a third party facility transactions service center, the database(s) 106 may be designed to store user profiles, such as the user profile mentioned above.

Referring back to the general functions of the application center 24, it is to be understood that similar to the data center live advisor 62, the application center live advisor 104 may be physically present at the application center 24 or may be located remote from the application center 24 while communicating therethrough.

The data center 100 and/or application center 24 components shown in FIG. 1 may also be virtualized and configured in a Cloud Computer, that is, in an Internet-based computing environment. For example, for the application center 24, the computer equipment 110 may be accessed as a Cloud platform service, or PaaS (Platform as a Service), utilizing Cloud infrastructure rather than hosting computer equipment 110 at the application center 24. The database 106 and server 109 may also be virtualized as a Cloud resource. The Cloud infrastructure, known as IaaS (Infrastructure as a Service), typically utilizes a platform virtualization environment as a service, which may include components such as the processor 108, database 106, server 109, and computer equipment 110. In an example, application software and services (such as, e.g., navigation route generation and subsequent delivery to the vehicle 12) may be performed in the Cloud via the SaaS (Software as a Service). Subscribers, in this fashion, may access software applications remotely via the Cloud. Further, subscriber service requests may be acted upon by the automated advisor 62′, which may be configured as a service present in the Cloud.

The communications network provider 90 generally owns and/or operates the carrier/communication system 16. The communications network provider 90 includes a mobile network operator that monitors and maintains the operation of the communications network 90. The network operator directs and routes calls, and troubleshoots hardware (cables, routers, network switches, hubs, network adaptors), software, and transmission problems. It is to be understood that, although the communications network provider 90 may have back-end equipment, employees, etc. located at the data center 100 and/or application center 24, the data center and/or application center is/are a separate and distinct entity from the network provider 90. In an example, the equipment, employees, etc. of the communications network provider 90 are located remote from the data center 100 and/or application center 24. The communications network provider 90 provides the user with telephone and/or Internet services, while the data center 100 and/or application center 24 provides a variety of telematics-related services (such as, for example, those discussed hereinabove). The communications network provider 90 may interact with the data center 100 and/or application center 24 to provide services (such as emergency services) to the user.

In the examples of the systems and method disclosed herein, the third party facility transactions service center may be managed by the data center 100. However, it is to be understood that the data center 100 may not be the sole entity that manages the transactions services, and the application center 24 may the designated entity for managing the third party facility transactions services.

Another example of a system 10′ for servicing the subscriber vehicle 12 will be described below in conjunction with FIG. 2. The system 10′ utilizes the system 10 of FIG. 1 and/or components thereof, as well as the third party facility 200 and the server 206 operatively associated therewith. The system 10′ further includes the subscriber vehicle 12 to which goods and/or services are to be provided from the third party facility 200.

The server 206 may be located at the third party facility 200 (e.g., inside the third party facility 200 building (not shown)), or may be located remote from the third party facility 200 (e.g., outside of the third party facility 200 building, down the street from the third party facility 200 building, in another city from the third party facility 200 building, or the like as shown in FIG. 2). The server 206 may otherwise be located at the data center 100 or the application center 24, and in such instances, may be part of or separate from the servers 70 (at the data center 100) or the servers 109 (at the application center 24).

Regardless of the server's location, the third party facility 200 may communicate with the server 206 utilizing a communications network 204. In an example, the communications network 204 may include a land network (such as the land network 22), or may be another network similar to the land network 22. In an example, the network 204 may include a public switched telephone network (PSTN) and/or an Internet protocol (IP) network, and one or more segments of the network 204 may be implemented in the form of a standard wired network, a fiber or other optical network, a cable network, other wireless networks, such as wireless local networks (WLANs) or networks providing broadband wireless access (BWA), or combinations thereof. In instances where the server 206 is located outside of the third party facility 200, the network 204 may take the form of a virtual private network (VPN), Internet network, or a wide area network (WAN). In instances where the server 206 is located inside the third party facility 200 building, it may be desirable to use a private wired network, such as an Intranet network.

It is to be understood that the server 206 is also in selective communication with the telematics data center 100 or application center 24 via another network 205. This network 205 may also take the form of a virtual private network (VPN), Internet network, or a wide area network (WAN).

The server 206 may be used as a backend office of the third party facility 200, and the server 206 may include a processor 212 and a memory 214 associated with the processor 212. As noted above, the server 206 may, in an example, be owned by the data center 100/application center 24 although the server 206 is physically part of the third party facility 200.

The server 206, in conjunction with the data center 100, may be configured to authenticate the vehicle 12 so that all of the entities involved have some level of trust for allowing the vehicle 12 to utilize the third party's network. In an example, the telematics service provider configures the server 206 to enable the server 206 to authenticate the vehicle 12 and to indicate to the vehicle 12 that it can further communicate utilizing the third party facility's network. For example, the data center 100/application center 24 may supply a time-based authentication certificate (such as an IEEE 802.1x certificate that expires, for example, in 1 hour) that may be stored locally in the server 206. An 802.1x certificate is an IEEE standard for port-based network access control (PNAC) over an IEEE 802 local area network (LAN). This mode of communication includes an authentication mechanism for those devices attempting to connect to a LAN or a wireless local area network (WLAN). Authentication may otherwise be accomplished using mutual IEEE 802.1x authentication. In these examples, the telematics unit 14 may review the time-based certificate, realize that the wireless access point is trustworthy by verifying the correct signature, and then establish the Wi-Fi™ connection with the device 202. Alternatively, a standard such as RADIUS may be used where the vehicle 12 authenticates directly with the data center 100 through the server 206. In this example, the vehicle 12 may initially provide credentials, such as a VIN or digital certificate, to the wireless access point 202 using extensible authentication protocol (EAP), and the wireless access point 202 forwards the credentials to the server 206, which proxies the credentials through to the data center 100 for verification. If the data center 100 determines the credentials are valid, the vehicle 12 will be allowed to access the third party network using any session keys provided by data center 100. The vehicle 12 may then transmit data to the data center 100 using the third party facility's network.

The processor 212 includes software programs for processing information and/or instructions received from the data center 100/application center 24 (e.g., contained in a notification message, which will be described in detail below). The processor 212 may also include a software program that includes a pairing algorithm that may be used to remotely pair the telematics unit 14 of the vehicle 12 with a BLUETOOTH® device at the third party facility 200 via a connection through the communications device 202. The pairing algorithm may be stored in the memory 214 of the server 206, and when executed by the processor 212, generates a wireless connection key for the device 202. As previously mentioned, the key may be used to establish short range wireless connections between the communications device 202 and the vehicle 12 (e.g., via a BLUETOOTH® connection). The key may also be used by the communications device 202 to establish its identity and authenticity for communicating with the telematics unit 14 of the vehicle 12 after the vehicle 12 has been authenticated by the telematics service provider, via the server 206. Details of a process for pairing the telematics unit 14 and the communications device 202 will be described below.

Additionally, the system 10′ may include a number of firewalls, such as firewall 207, firewall 208, and firewall 210. These firewalls 207, 208, and 210 are devices or sets of devices specifically designed to permit or deny data transmissions through the land network 22. In other words, the firewalls 207, 208, 210 are used to protect the land network 22 from unauthorized access, while authorized transmissions are permitted to pass through.

The third party facility 200 may be an establishment, organization, business, or the like that provides goods and/or services to customers (such as to the subscriber vehicle 12). In some cases, the third party facility 200 sells the goods and/or services to the subscriber vehicle 12, e.g., in exchange for some form of payment. The payment for the goods and/or services may take the form of money, another service, another good, and/or the like. In other cases, the third party facility 200 provides goods and/or services that are free of charge. These goods and/or services may include solicited services (e.g., a request for free information) or unsolicited services and/or goods (e.g., advertisements and/or coupons). Some examples of the third party facility 200 include restaurants (e.g., fast food restaurants, dine-in restaurants, etc.), convenience stores, grocery stores, vehicle service stations, laundry or dry cleaning facilities, department stores, boutique stores, dealerships, and/or the like.

As shown in FIG. 2, the third party facility 200 may include one or more clerks 218 for servicing subscriber vehicles 12. The clerk 218 may utilize information received from the server 206 and/or from the data center 100 to complete a commercial transaction with the subscriber vehicle 12. In an example, an advisor 62, 62′ at the data center 100 may store credit card information for a vehicle 12 and this information could be transmitted to a payment terminal at the third party facility 200. In an example, the information is transmitted from the server 206 to a processor operatively associated with a clerk workstation (not shown), and the information may be displayed on a display screen of the clerk workstation. The clerk workstation may be one of several workstations that are run by a single processor, or each workstation may have its own internal processor.

An example of a method for providing services to the subscriber vehicle 12 will now be described hereinbelow in conjunction with FIGS. 1-5.

At the outset, the facility 200 enters into a contract or some agreement with the telematics service provider that designates the third party facility 200 as a participant in the third party facility transaction service offered by the telematics service provider. Once the agreement is in place, the telematics service provider may offer to its subscriber vehicles (e.g., the vehicle 12) the opportunity to participate in the third party facility transaction service program.

It is to be understood that the examples of the method disclosed herein may be accomplished so long as an account has been set up with the telematics service provider, and the owner of the account has joined a service for facilitating third party facility transactions with the vehicle 12. As used herein, the term “account” refers to a representation of a business relationship established between the user and the owner of the data and application centers 100 and 24, where the business relationship enables the user to request and receive services from the data center 100 and, in some instances, the application center 24. The business relationship may be referred to as a subscription agreement/contract between the user and the owner of the data center 100 and application center 24, where such agreement generally includes, for example, the type of services that the user may receive, the cost for such services, the duration of the agreement (e.g., a one-year contract, etc.), and/or the like. In an example, the account may be set up by calling the data center 100 and requesting to (or selecting from a set of menu options) to speak with an advisor 62 to set up an account. In an example, the switch 68 at the data center 100 routes the call to an appropriate advisor 62, who will assist the user with opening and/or setting up the user's account. When the account has been set up, the details of the agreement established between the data center 100/application center 24 owner and the user, as well as personal information of the user (e.g., the user's name, garage address, home phone number, cellular phone number, electronic mailing (e-mail) address, etc.) are stored in the user profile in the database 72 at the data center 100. The user profile may be used by the data center 100 and/or the application center 24, for example, when providing requested services or offering new services to the user.

When new services become available or a user has not yet signed up for existing services (such as, e.g., a service facilitating third party facility transactions with the vehicle 12), the data center 100 or the application center 24 may notify the user of the new services during a voice call between the user and data center 100 or the application center 24. The call may be initiated by either the user or the data or application center 100 or 24. During the call, the advisor 62 or 104 may notify the user of the service, and also ask the user if he/she would be interested in signing up for the service. If the user is conversing with an advisor 62, 62′ at the data center 100 when he/she indicates that he/she would be interested in the service, the advisor 62, 62′ i) may sign the user up, ii) may provide the user with a phone number that he/she may use to directly access the third party facility transactions service division at the data center 100 or application center 24 to sign up for the service, or iii) may route the user's call to the division at the data center 100 or the application center 24 responsible for setting up and managing the service for facilitating third party facility transactions with the vehicle 12.

In another example, the user may be solicited by the data center 100 (or application center 24 if designated for providing the specific services). In one example of such a solicitation, an advisor 62 at the data center 100 calls the user directly on his/her cellular phone. During the call, the user may be informed of the availability of the new service, and invite the user to sign up. The user may sign up for the service, if he/she so desires, during the same voice call with the data center 100. In another example of such a solicitation, the data center 100 (or application center 24 if designated for providing the specific services) may transmit an invitation to a user's account to join a new (or existing but not yet joined) service (e.g., the service for facilitating third party facility transactions with the vehicle 12). In this example, the data center 100 may retrieve the user's e-mail address from his/her profile stored in the database 72, and then e-mail the invitation to the user. The invitation also includes instructions indicating how the user can go about signing up for the service, and a phone number for directly accessing the appropriate division at the data center 100 (or application center 24). Using the phone number listed in the invitation, the user may directly contact the appropriate division, and sign up for the service during the phone call.

The invitation may also include a request for authorization information and/or for one or more phone numbers of communications device(s) (e.g., the telematics unit 14, a cellular phone, a home phone, etc.) that the user is likely to use to contact the data center 100 or the application center 24. The authorization information and/or the phone number(s) of the communications device(s) may be stored in the user's profile and subsequently used, by the data center 100 (or application center 24), to authenticate a caller attempting to make changes to his/her account, to set up preferences associated with the service, etc. For instance, if the caller establishes a voice connection with the data center 100 (via, e.g., a voice call using the telematics unit 14 as the communications device), the data center 100 may attempt to match the phone number of the device from which the call was made with the phone number submitted by the user in response to the invitation for the service. If the two phone numbers match, the data center 100 will assume that the caller is authorized to make changes to his/her subscription agreement pertaining to the third party facility transactions service.

Authorization information may also be used, by the data center 100, to authenticate a caller. For instance, when accepting the invitation to sign up for the third party facility transaction service, the user may provide authorization information which may be used as answers to prescribed challenges presented to a caller when attempting to make changes, e.g., to preferences contained in his/her user profile stored at the data center 100. The prescribed challenges may include a question or request for information relating to personal information of the user, such as, e.g., “What is your mother's maiden name?”, “What was the name of your first pet?”, “Describe the color of your first car”, and/or the like. The answers to these questions or requests (i.e., the personal or authorization information) are originally answered by the user in response to the invitation, and the answers are also stored in the user profile at the data center 100. When the caller attempts to make changes to his/her user profile, for instance, the caller will be presented with the challenges, and if answered correctly, the caller will be authorized to make the changes.

It is to be understood that the application center 24 may also be configured to perform the authorization of the caller in those instances where the application center 24 is configured to provide the third party facility transaction service to the subscriber vehicle 12.

When sent in an electronic mail format, the invitation to join the service may also include a hyperlink that, when selected (e.g., via a mouse click) by the user, takes the user to a webpage (not shown) associated with the data center 100 or the application center 24. The user may then sign up for the service using that webpage. During the sign-up session, the user also submits, to the webpage, the requested authorization information and phone number(s) associated with the user's mobile communications device(s).

Once the user has signed up for the third party facility transaction service, the processor 84 at the data center 100 will identify the user's vehicle 12 as a participant of the service. In an example, the identification process may involve marking/flagging the user's profile as a participating vehicle 12 for the length of time designated in the user's subscription agreement. For instance, once the user has signed up for the third party facility transactions service, he/she may use the service to obtain goods and/or services from third party facilities (e.g., the facility 200) via the examples of the method described herein. It is to be understood that the service may be used for the amount of time defined in the user's subscription agreement for the service. For instance, if the user signs up for the service for six months, the user may use the service as often as desired during the six month subscription agreement. When the six month duration of the service is about to elapse (e.g., two weeks before the expiration, or at some other predefined period), for example, the data center 100 may transmit one or more renewal invitations to the user to re-sign up for the service.

While signing up for the third party facility transactions services, the user may also select preferences that are stored in his/her user profile in one of the databases 72 at the data center 100 or one of the databases 106 at the application center 24. It is to be understood that the user may select his/her preferences after signing up for the third party facility transactions services. This may be accomplished, e.g., by calling the data center 100 or application center 24, and requesting to an advisor 62 or 104 to select preferences for the service. The user may recite his/her preferences to the advisor 62, 104 during the phone call, and the advisor 62, 104 (who has access to the user's account) stores the user-selected preferences in the user profile. The user may also work his/her way through automated menu options when selecting preferences during a phone call, as opposed to talking with a live advisor 62 or 104. The user may also select his/her preferences by accessing the webpage 96 (e.g., by submitting an appropriate login and password), and selecting and/or inputting his/her preferences into the webpage 96. Yet another way of selecting preferences include sending an electronic mailing (e-mail) message to the data center 100/application center 24, where the e-mail message includes the user's preferences. The data center 100/application center 24 (via a software program run by the processor 84, 108) extracts the user's preferences from the e-mail message and stores them in the user profile.

The user-selected preferences may include, for example, a list of third party facilities that the user wishes to participate with in the third party facility transactions service. For instance, the user may select certain fast food restaurants that should be included, such as McDONALD'S®, WENDY'S®, and BURGER KING®, while excluding all other fast food restaurants. The user may also select the type of third party facility that should be included, while the un-selected types are excluded. For example, the user may select to have the third party transactions service applied to all banking facilities and vehicle service stations, but not to fast food restaurants. In some cases, the user may select certain third party facilities, as well as certain types of third party facilities that should be included for participation in the service with the user. An example of this scenario, the user may include McDONALD'S®, PNCBANK®, and vehicle service stations.

In an example, the third party facility transactions service may be applied to a default geographic region, which may be determined by a boundary defined by a radius around a garage address of the user's residence. This radius may be determined, for example, based on the type of geographic area that the user's garage address is located. If, for instance, the user's garage address is located in an urban area, then the radius defining the boundary around the user's garage address in the urban area may be much smaller than a radius defining the boundary around the user's garage address if the user's residence is in a rural area. The geographic region may otherwise be based on a user's selected center point, such as a business address rather than the user's garage address. Further, the radius of the boundary defined around the center point may be adjusted by the user (e.g., upon calling the data center 100/application center 24 and speaking with an advisor 62, 104 or an automaton 62′, 104′, by accessing the webpage 96, or the like), or may be dynamically adjusted based on driving habits of the user or other heuristic data that was previously stored in the user profile.

The preferences may also include types of goods and/or services that may be provided to the vehicle 12 by the third party facility 200 during servicing, and perhaps some stipulations for the selection or preparation of certain goods and/or services. For instance, the user may select to have restaurant A as a participating third party facility, but may stipulate that the restaurant may provide any food on the menu to the vehicle 12 except for French fries. In another instance, the user may select to have bank B as a participating third party facility, but may stipulate that the bank is not to authorize any withdrawals by the vehicle 12 from a particular banking account. In yet another instance, the user may select to have coffee shop C as a participating third party facility, but may stipulate that any beverages provided by the coffee shop to the vehicle 12 should be prepared with decaffeinated coffees, espressos, and/or teas. In still another instance, the user may indicate that he/she has a food allergy to alert a particular restaurant that orders delivered to the vehicle 12 should be in accordance with the food allergy. These types of preferences may be transmitted from the data center 100/application center 24 to the third party facility 200 during an example of the method described herein, and may be used by the third party facility 200 to properly service the vehicle 12.

In an example, the user may also provide payment information as a preference in his/her user profile. The payment information may take the form of a credit card number, a debit card number, pre-paid points with the telematics service provider that may be used for completing third party facility transactions, and/or the like, and/or combinations thereof. As will be described in further detail below, the data center 100/application center 24 may, as part of an example of the method, transmit the user-selected payment information to the third party facility 200 upon servicing the vehicle 12 so that the vehicle 12 occupant(s) does/do not have to render payment himself/herself/themselves.

It is to be understood that the preferences are set until the authorized user accesses the webpage 96 or contacts the data center 100 and/or application center 24, and removes or otherwise changes the preferences associated with the third party facility transactions services. The removed/changed preferences will take effect as soon as they are stored in the user profile, and remain as active preferences until the user's subscription with the telematics service provider expires or is canceled, or for the duration predefined by the user. It is further to be understood that authorized persons alone are allowed to remove/change the preferences stored in the user profile, and those that are authorized to remove/change the preferences are pre-established by the user who originally set up the subscription account, or by others who the user has indicated as being authorized to change the preferences. Those that are authorized to remove/change the preferences may be identified, by the user, when the preferences are originally set up and/or may be added or removed at any subsequent time.

After the user has signed up for the service through the data center 100 or the application center 24, the telematics unit 14 of the user's vehicle 12 is configured to establish wireless connections with communications devices 202 at various third party facilities 200. In some instances, the communications devices 202 are wireless access points (WAPs) at the third party facilities 200 so that vehicles (such as the vehicle 12) can establish a short range wireless connection with the communications devices 202 when the vehicles 12 are within wireless connection range therewith. An example of a communications device 202 that is a WAP is shown in FIG. 2. This device 202 may include one or more directional antennas (not shown) that propagate a wireless signal at a predefined transmission power, and the vehicle 12 may be pre-configured (e.g., by having the SSIDs stored in the memory 38 of the telematics unit 14, which were mentioned above and are described in further detail below) to automatically connect with the device 202 when the vehicle 12 is within wireless connection range of the device 202.

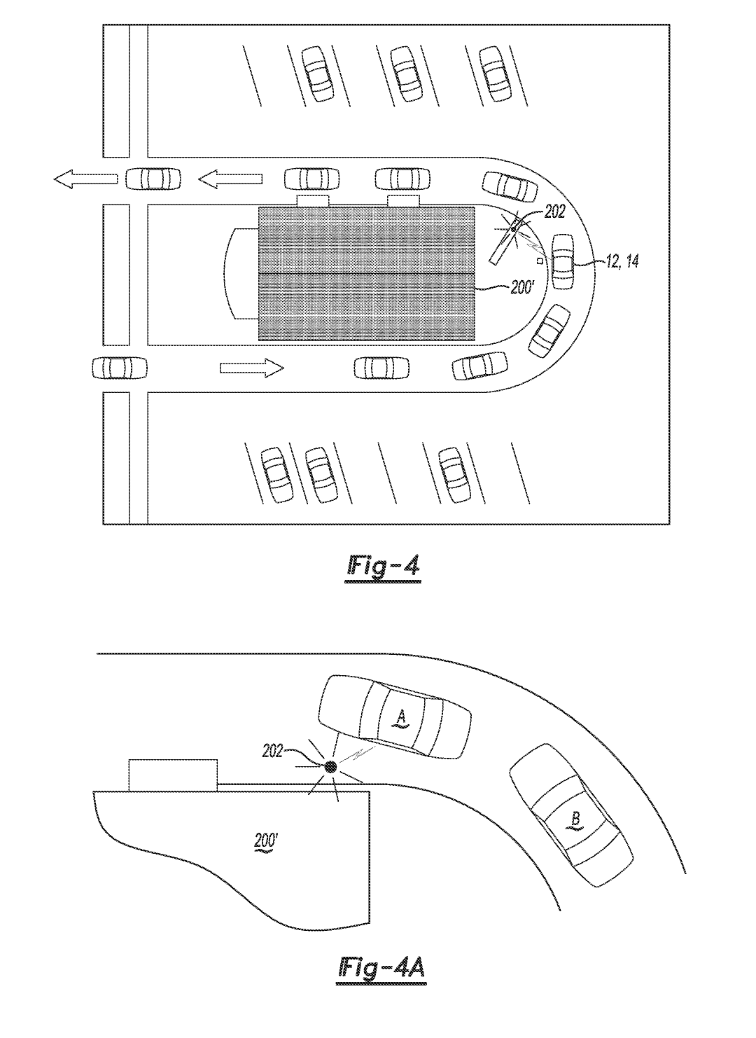

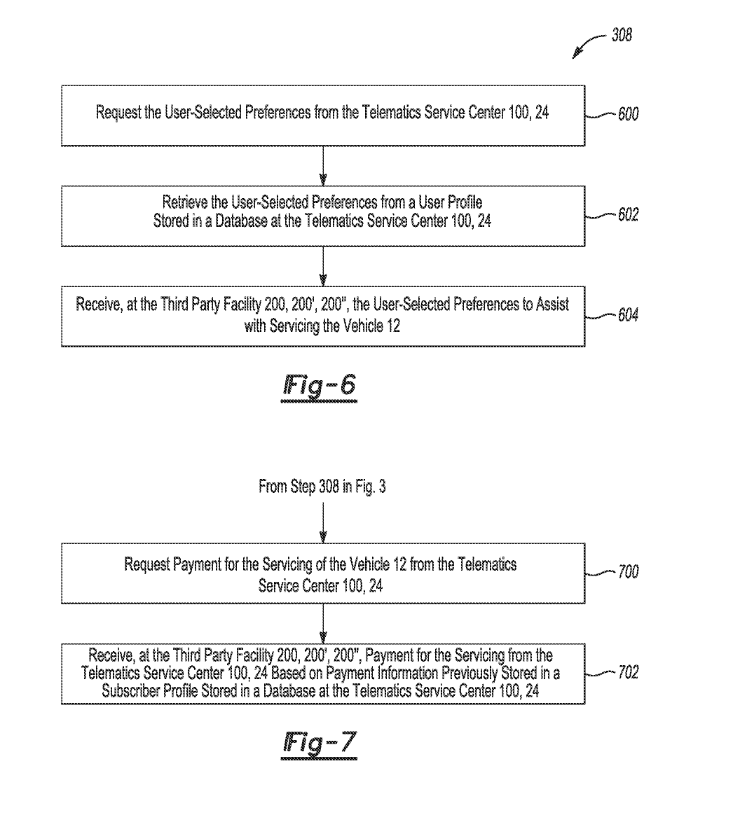

One example of pre-configuring the vehicle 12 involves configuring the telematics unit 14 to establish a wireless connection with the device 202 utilizing an activated service set identifier (SSID). For example, the telematics unit 14 may have stored in the memory 38 thereof a number of access point identifiers that correspond to the devices 202/WAPs associated with the third party facilities 200. In an example, a unique identifier is present for each device 202/WAP. Since each memory 38 has a limited amount of memory, the SSID allocation may be limited, in some instances and for example, to larger third parties and a catch-all SSID for smaller companies. These identifiers may be stored in the memory 38, e.g., at the time of manufacture, by the dealership, or the like, or are downloaded to the telematics unit 14 by the data center 100/application center 24 when the user signs up for the third party facility transactions service. In an example, one, two, or a selected number of identifiers (either previously stored in, or downloaded to the telematics unit 14) are activated so that the vehicle 12 can connect with those communications devices 202/WAPs at, e.g., user-selected third party facilities 200. It is to be understood that the access point identifiers that are activated include those that are associated with communication devices 202 located at third party facilities 200 falling within the default geographic region mentioned above, or those communication devices 202 associated with third party facilities 200 that have been previously selected, e.g., by the user as being a participant in the third party facility transactions service that are stored in the user's profile. For instance, the user may have selected to have the third party facility transactions service applied for certain third party facilities; such as for fast food restaurants A and B, pharmacy X, and all Y brand car dealerships. Thus, the data center 100/application center 24 may send a signal or message to the telematics unit 14 with instructions to activate all of the access point identifiers associated with the selected facilities mentioned above that are within a user-selected or default geographic region. In an example, a single access point identifier may be used for each franchise of a single third party facility 200, 200′ (FIGS. 4 and 4A), 200″ (FIG. 5), such as all franchises of coffee shop C within a single geographic area. In another example, a single access point identifier may be used for a type of third party facility 200, 200′, 200″, such as for all fast food restaurants within a particular geographic region. In some instances, an access point identifier may be provided for each third party facility within a particular geographic region depending, at least in part, on the number of facilities present in the geographic region. In other words, in some examples, a unique identifier may be used for each WAP 202 in that geographic region. In instances where many facilities may be present in a given geographic region, then the number of access point identifiers may be reduced by using access point identifiers that identify particular facilities rather than types of facilities.

The SSID may also be specific to a particular restaurant, bank, etc. across an entire country (e.g., the United States). For example, bank A may have the same SSID regardless of where a particular branch is located. The vehicle 12 arrives at bank A, and after the initial vehicle 12 authentication takes place, sends a packet data message to the data center 100 via the connection with communications device 202. The data center 100 may then determine, based on customer preferences, whether to notify bank A (i.e., third party facility 200) of the vehicle's presence at the particular branch. It is further to be understood that the user may un-select certain third party facilities 200 to be participants in the third party facility transactions service, and may do so by submitting another request to the data center 100/application center 24. In response to the de-activation request, the user's profile will be updated with such information, and the data center 100/application center 24 sends another signal or message to the telematics unit 14 with instructions to de-activate the previously activated identifiers associated with the un-selected third party facilities 200. When de-activated, the identifiers may be removed from the memory 38 to free up space for other data, information, activated identifiers, etc. In many instances, however, once an identifier is activated, it may also remain active.

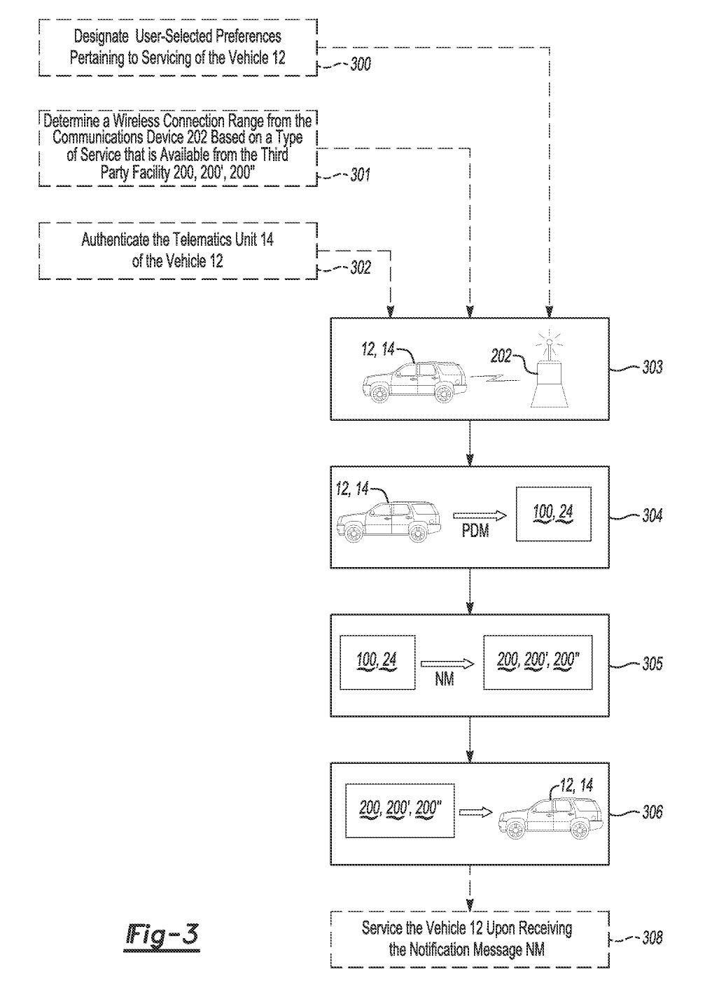

Referring now to FIG. 3, an example of the method disclosed herein includes establishing a connection between the telematics unit 14 of the vehicle 12 and the communications device 202, as shown by reference numeral 300. The communications device 202 is generally configured to establish point-to-point, short range wireless connections with the telematics unit 14 when the telematics unit 14 is within wireless connection range of the device 202. As mentioned above, the communications device 202 may be a wireless access point (WAP), and may be capable of establishing Wi-Fi™ connections with the telematics unit 14. In another example, the communications device 202/WAP may be capable of establishing BLUETOOTH® connections with the telematics unit 14.

It is to be understood that the SSID used to establish the Wi-Fi™ connection may, in some instances, be determined and potentially duplicated by others desiring to access the services from the third party facility 200. As such, it may be desirable that the vehicle 12 be authenticated by the telematics service provide prior to allowing the vehicle 12 to fully utilize the Wi-Fi™ connection. As mentioned above, authentication may take place with a certificate present on the server 206 or via a program such as RADIUS.

The wireless access range for establishing Wi-Fi™ connections may be preset depending, at least in part, on the type of third party facility 200 and how the third party facility 200 services vehicles. This may be accomplished, for example, by presetting the propagation of the short range wireless signal, as well as the transmission power of the signal. The controlled, or preset wireless access range may be useful, e.g., when the subscriber vehicle 12 is one of many vehicles requesting services from the third party facility 200, and the order of servicing the vehicles is important. For instance, an example of the third party facility 200′ is shown in FIG. 4, and this facility 200′ includes a drive thru line. Examples of such facilities 200′ include fast food establishments, drive thru banking facilities, drive thru coffee shops, drive thru pharmacies, and the like. The drive thru line may be used, e.g., to service vehicles without vehicle occupants having to step out of their respective vehicles. Servicing of the vehicles by the facility 200′ is typically based on a predefined order of vehicles, and such order may be defined by when the vehicles arrive at the facility 200′ and enter the drive thru line. Typically, the vehicles in a drive thru line are positioned in a single-file formation, where the vehicle at the front of the line (e.g., the first vehicle in line) is serviced before the next vehicle (e.g., the second vehicle in line).

The drive thru line may, in an example, be configured so that a vehicle occupant can place an order at a microphone (which may, e.g., be part of an order menu for a fast food restaurant, a standalone microphone for a pharmacy drive thru line, or the like), and the microphone is located adjacent to the drive thru line so that a vehicle driver can speak into the microphone (and thus place an order or make a request) when the vehicle 12 pulls up to the microphone. The order placed or request made by the driver may be picked up and recorded by a clerk at a pay window downstream from the microphone in the drive thru line. According to an example of the method disclosed herein, the communications device 202 may be positioned adjacent to the microphone in the drive thru line, and may be preset to a wireless access range so that the vehicle that is then-currently at the microphone is within wireless connection range of the device 202. Assuming that the vehicle 12 has signed up for the third party transactions services, the vehicle 12 can then establish a wireless Wi-Fi™ connection with the communications device 202.

It is to be understood that the preset wireless access range should be large enough so that the vehicle that is then-currently at the microphone can connect with the device 202, but small enough so that the next vehicle in line is outside of the wireless connection range. This situation is shown in FIG. 4A, where the vehicle (such as vehicle A) is within the wireless connection range of the device 202, but the next vehicle (such as vehicle B) cannot establish a wireless connection with the device 202 because vehicle B is outside of the wireless connection range. The limited wireless connection range of the device 202 enables the vehicles A, B to be serviced in order based on the positioning of the vehicles A, B in the drive thru line. In an example, the wireless access range of the communications device 202 when used at third party facilities having a drive thru line (e.g., the facility 200′) may be set using a BLUETOOTH® connection with a power class of 1 m (˜3 ft) or by controlling the WiFi™ signal propagation or strength so that the wireless connection range is from about 3 feet to about 6 feet.

In another example, the preset wireless access range may be large enough so that two or more vehicles that are then-currently in the drive-through line can connect with the device 202. This may occur, for example, when the preset wireless access range corresponds with the default BLUETOOTH® range of about 10 m (˜32 ft) or the default WiFi™ range of about 103 m (˜338 ft). In this example, the service order of the vehicles (e.g., vehicles A and B) may be determined, at least in part, by their respective GPS location data relative to the GPA location data of the WAP/device 202. Upon establishing a wireless connection with the WAP 202, the packet data message sent to the data center 100/application center 24 from the telematics unit 14 of, e.g., vehicle A may include GPS coordinate data of the vehicle A. In a similar manner, vehicle B may transmit its then-current GPS coordinate data. The data may be used to determine which of the vehicles A, B is closer to the WAP/device 202. In an example, if the data center 100/application center 24 (via processors 84, 108, respectively) determines that the vehicle A is closer to WAP 202 than vehicle B, the processor 84, 108 will determine that vehicle A should be serviced before vehicle B.

In another example, the preset wireless access range may not be associated with an order of vehicles 12 (e.g., A and B) to be serviced by the third party facility 200, 200′. In some of these cases, the wireless connection range may be set to a much larger range than that used for facilities 200, 200′ having a drive thru line. As shown in FIG. 5, an example of a third party facility 200″ that can service a vehicle 12 without the order of vehicles being pertinent may be a car dealership, a retail store, and/or the like. The facility 200″ may, e.g., provide goods and/or services (such as free advertisements, coupons, etc.) to any vehicle 12 entering the facility 200″ parking lot so long as the vehicle 12 has signed up for the third party facility transactions service.

The wireless access or connection range may, in an example, depend on where the communications device 202 is positioned at the facility 200″. In instances where the services provided to vehicles entering the facility 200″ parking lot are advertisements or the like, then the communications device 202 may be placed near the entrance of the facility 200″ parking lot, as shown in FIG. 5. When the communications device 202 is placed next to the entryway of the parking lot, the wireless connection range may be preset to be as large as the width of the entryway (such as, e.g., ranging from about 8 feet to about 12 feet, or however wide the entryway is). In some cases, it may be desirable to set the wireless connection range, e.g., by adjusting a power level to control signal strength, by using repeaters or outdoor directional antennas (to extend WiFi™), or by selecting a particular BLUETOOTH® power class, to a value that is much larger than the width of the entryway. This may be desirable so that vehicles 12 (that have signed up for the third party facility transactions service) on the roadway passing by the facility 200″ may also automatically connect with the communications device 202 and receive advertisements without having to pull into the parking lot. In this case, the wireless access or connection range may be as large as about 100 feet, or even 500 feet. If, for instance, outdoor directional antennas are used with the communications device 202, the wireless access or connection range may be increased into the kilometer range.

Still another example may involve those third party facilities 200 that offer to-go services. Each vehicle 12 utilizing the connection would be matched to an order and the third party facility 200 could be notified of the proximity of the vehicle 12 based upon location data transmitted from the vehicle 12 to the data center 100 utilizing the connection.

It is to be understood that, in some cases, a plurality of WAPs (devices 202) may be available in a given area that the vehicle 12 may be able to connect with. For instance, a WAP 202 may be available at store A, store B, and store C, all of which are within wireless connection range of the telematics unit 14 of the vehicle 12 at the same time. In this case, a list of available WAPs 202 may be presented to the telematics unit 14, and the telematics unit 14 may select which one of the WAPs 202 to connect with. In one example, the telematics unit 14 may select the WAP 202 based on signal strength, where the telematics unit 14 connects with the WAP 202 whose signal strength is stronger than the other WAP 202. In another example, the telematics unit 14 may select the WAP 202 based on a predetermined priority, which may be determined by a default setting (e.g., a WAP 202 at a dealership may have been preset to have priority over a WAP 202 at McDONALD'S®), based on a user-selected priority (e.g., the user may have selected a higher priority for dealerships than for fast food restaurants), or based on heuristic data (e.g., the telematics unit 14 may determine that the user frequents fast food restaurants, and thus gives a higher priority to McDONALDS® than to dealerships).

It is to be understood that multiple WAPs (devices 202) in a given area that the vehicle 12 may connect with may be avoided, in some cases, by strategically placing the WAPs 202 so that a single WAP 202 is within wireless connection range of the telematics unit 14 at a time. For instance, a WAP at McDONALD'S® may be placed so that its signal does not propagate to a distance that interferes with the signal of another WAP 202 located at a store that is next to McDONALD'S®. In this way, the vehicle 12 does not have to select which WAP 202 to connect with.

In another example, the communications device 202 at the third party facility 200, 200′, 200″ may be configured to establish BLUETOOTH® connections with the telematics unit 14 of the vehicles 12. Such short range wireless connections may be established once the devices 14, 202 have been paired, and the devices 14, 202 are within short range wireless connection range with one another. The pairing process may include a remote pairing of the telematics unit 14 and the communications device 202, which may be requested by the third party facility 200, 200′, 200″ during subscriber/user interaction with the third party facility 200, 200′, 200″, or by an automated process. For instance, a user may pull his/her vehicle into a dealership parking lot, and the communications device 202 at the dealership may not be able to perform vehicle services using the telematics unit 14 of the vehicle 12. The dealership may then request that a pairing process be performed so that the dealership communications device 202 can establish a connection with the telematics unit 14, e.g., to provide advertisements, etc. to the vehicle 12. In this case, the vehicle 12 sees the dealership WAP 202 and connects (without a specific relationship between the customer and dealer) using the method described herein. Using the connection, the vehicle 12 contacts the data center 100, and the data center 100 notifies the dealership of the vehicle's presence (as is described further hereinbelow). The dealership would then request specific services (e.g. ability to send audio to the vehicle 12, or collect vehicle data such as odometer reading, diagnostic codes, oil life, fluid levels, etc.). The specific services may include sending a pairing request between the vehicle and a BLUETOOTH® device at the dealership. Direct communication with the vehicle 12 may also be desirable with other automotive related third party facilities, such as rental locations or service centers.

It is to be understood that once device 202 at the dealership has been paired with the telematics unit 14, short range wireless connections may be established between the two devices 14, 202 whenever the vehicle 12 enters the dealership parking lot. For instance, the telematics unit 14 may continuously monitor for the presence of the device 202 using a short range wireless antenna 51, and attempts to connect with the device 202 upon recognizing the presence of the device 202 (which, in the instant example, may occur when the vehicle 12 pulls into the parking lot of the dealership). In another example, the device 202 of the facility 200, 200′, 200″ may continuously monitor for the presence of the telematics unit 14 using its own short range wireless antenna (not shown). The device 202 attempts to connect with the telematics unit 14 upon recognizing the presence of the telematics unit 14; which typically occurs as soon as the telematics unit 14 is positioned within the short wireless range of the device 202. The device 202 or the telematics unit 14 alone may be configured to monitor for the presence of the other device, or both of the devices 14, 202 may be configured to simultaneously monitor for the presence of the other device. It is further to be understood that the device 202 and the telematics unit 14 attempt to connect during each encounter between the devices 14, 202 after the devices 14, 202 have been paired. In other words, once the two devices 14, 202 have been paired and whenever they are within short range wireless communication range of each other, the telematics unit 14 can directly communicate with the device 202.

In another example, the customer may opt in to a relationship with the third party facility 200, 200′, 200″ by accessing a third party facility 200, 200′, 200″ webpage, or the webpage 96 associated with the data center 100/application center 24. In the latter case, the webpage 96 may be accessed directly by the user, or the user may call the data center 100/application center 24 and speak with an advisor 62, 104 or to an automaton 62′, 103′ who may access the webpage 96 for the user. In yet other instances, an event (such as the sale of a vehicle by the dealership) may trigger an automated process through which keys are generated and stored in respective memories 38, 214 of the vehicle 12 and the third party facility 200, 200′, 200″. In an example, different keys are exchanged at each third party facility 200, 200′, 200″, and in another example, the same key may be exchanged for all of the third party facilities 200, 200′, 200″ (i.e., a single BLUETOOTH® address may be used for establishing short range wireless connections with several different third party facilities 200, 200′, 200″). These key(s) (i.e., security codes) is/are exchanged for establishing subsequent BLUETOOTH® connections between the devices 14, 202.

Referring back to FIG. 3, the method further involves sending a packet data message (PDM) from the telematics unit 14 to the data center 100/application center 24, as shown by reference numeral 302. The packet data message may be sent to the data center 100/application center 24, for example, utilizing a wireless Internet (i.e., a transmission control protocol/internet protocol (TCP/IP)) connection. In an example, the packet data message is sent to the data center 100/application center 24 using a source internet protocol (IP) address of the in-vehicle telematics unit 14, which may be a private IP address. The packet data message traverses the third party facility 200, 200′, 200″ network 204, 205, 22 as the packet data message crosses over into the Internet. At this point, the firewall 208 of the third party facility 200, 200′, 200″ saves the information contained in the packet data message, and then replaces the source IP address with an IP address associated with the third party facility 200, 200′, 200″. The packet data message then traverses the Internet, and arrives at the data center 100/application center 24 having the IP address of the third party facility 200, 200′, 200″. In these examples, the packet data is transmitted using the Internet, and is not transmitted through a cellular network.

Alternatively, the IP address of the in-vehicle telematics unit 14 could be a non-private address that is associated with the third party facility that does not undergo network address translation (NAT).

The packet data message is received by the communications module 86 at the data center 100, which identifies the packet data message as one pertaining to the third party facility transactions service. Upon making this identification, the communications module 86 transmits the data message to the processor 84 at the data center 100 for identifying the third party facility 200, 200′, 200″ and for processing of any data contained in the message. In another example, the packet data message may be received by the communications module 86 at the data center 100, which identifies the packet data message as one pertaining to the third party facility transactions service. Upon making this identification, the communications module 86 at the data center 100 transmits the packet data message to the communications module 116 at the application center 24 that is specifically designed to handle the third party facility transactions service. The communications module 116 at the application center 24 then transmits the packet data message to the processor 108, which identifies the third party facility 200, 200′, 200″ and processes any data contained in the message.

In an example, the processor 84, 108 uses the IP address of the third party facility 200, 200′, 200″ to determine the location of the third party facility 200, 200′, 200″, and such information may also be used to identify the third party facility 200, 200′, 200″. The processor 84, 108 performs a database look up of the IP address of the packet data message (which is the IP address of the third party facility 200, 200′, 200″), which will return the identification and location of the third party facility 200, 200′, 200″.

The data contained in the packet data message may include information pertaining to the identity of the vehicle 12, such as a vehicle identification number (VIN), a mobile dialing number (MDN) of the telematics unit 14, and/or the like. The processor 84 at the data center (or the processor 108 at the application center 24) uses the vehicle 12 identification information to identify the vehicle 12, and this may be accomplished, e.g., by searching a database including an identification of all of the subscriber vehicles and the names of the associated owners. Once the owner's names have been retrieved from the database, the processor 84, 108 retrieves the appropriate user profile from the database 72 at the data center 100 (or the database 106 at the application center 24) to obtain further information of the owner (i.e., the subscriber) and his/her vehicle 12. The processor 84, 108 also retrieves information from the user profile that is pertinent to the imminent third party facility transaction, which may have been stored in the user profile as user-selected preferences (such as those described above).

In an example, the packet data message may also contain then-current location information of the vehicle 12, which may be GPS coordinate data retrieved by the telematics unit 14 from the in-vehicle location component 44. In some instances, the processor 84, 108 utilizes the then-current location information of the vehicle 12 as a secondary aid to the IP address for determining the location of the third party facility 200, 200′, 200″.

In an example, the processor 84, 108 utilizes the information retrieved from the user profile, and formulates a notification message (NM) to be sent from the data center 100/application center 24 to the third party facility 200, 200′, 200″. This is shown by step 304 in FIG. 3. The notification message may be sent directly from the communications module 86 at the data center 100, or the communications module 116 at the application center 24 to the third party facility 200, 200′, 200″ as another packet data message utilizing the same, or another IP address of the facility 200, 200′, 200″. The notification message may, for example, contain enough information to apprise the third party facility 200, 200′, 200″ that the vehicle 12 is available for servicing. Some specific details contained in the message may include an identification of the vehicle (e.g., the make and model of the vehicle 12 so that the facility 200, 200′, 200″ can easily identify which vehicle is being serviced at that time), the name of the vehicle owner, and any preferences pertaining to the goods and/or services to be provided to the vehicle 12 by the third party facility 200, 200′, 200″.

It is to be understood that, at this time, the data center 100/application center 24 is connected to the vehicle 12 via an Internet connection initiated by the Wi-Fi™ connection established between the telematics unit 14 and the communications device 202, and is connected to the third party facility 200, 200′, 200″ via a separate, direct connection. It is further to be understood that the third party facility 200, 200′, 200″ can establish a direct connection with the vehicle 12 (e.g., between the third party facility 200, 200′, 200″ internal system and the telematics unit 14) or an indirect connection with the vehicle 12 (e.g., between the third party facility 200, 200′, 200″ and the processor 212 which is owned by the data center 100/application center 24). A direct connection may take place when BLUETOOTH® devices at the third party facility 200, 200′, 200″ are allowed to connect to the telematics unit 14. In some instances, an indirect connection with the vehicle 12 may be established, e.g., by establishing a connection with the data center 100/application center 24, and then the data center 100/application center 24 can communicate directly with the telematics unit 14 via the Wi-Fi™ connection.

The third party facility 200, 200′, 200″ may use the direct or indirect connection with the vehicle 12 so that the facility 200, 200′, 200″ can communicate with the vehicle 12 occupants in order to service the vehicle 12. This is shown by step 306 in FIG. 3. Communication may be accomplished, e.g., via voice communications through the telematics unit 14 of the vehicle 12. For instance, a clerk 218 at the facility 200, 200′, 200″ may engage in voice communications with the vehicle 12 occupant(s), where the clerk 218 may ask the vehicle 12 occupant(s) for his/her/their order/request. The utterances recited by the clerk 218 are played through the speakers 30, 30′ that are operatively connected to the in-vehicle audio component 60, which is in communication with the telematics unit 14 via the bus 34. The vehicle 12 occupant(s) may recite his/her/their order to the clerk 218, by reciting the order into the microphone 28 that is operatively connected to the telematics unit 14.

Communication between the facility 200, 200′, 200″ and the vehicle 12 may otherwise be accomplished via data communications. For instance, the clerk 218 at the facility 200, 200′, 200″ may submit his/her request for the vehicle 12 occupant(s) order as a data message to the vehicle 12, where such data message is shown on the in-vehicle display 80. The vehicle 12 occupant(s) may respond to the order request by inputting his/her/their order using a user interface, such as a touch screen. The vehicle 12 occupant(s) may otherwise input the order by verbally reciting the order into the microphone 28.

In some cases, the third party facility 200, 200′, 200″ may refer back to the notification message for any user-selected preferences that may pertain to a then-current order. In instances where the user-selected preferences are available from the notification message, the facility 200, 200′, 200″ may apply those preferences. However, if no preferences are available, the third party facility 200, 200′, 200″ may send a request to the data center 100/application center 24 for the user-selected preferences so that the facility 200, 200′, 200″ can apply those preferences to the then-current order. The request may be made during a direct connection with the data center 100/application center 24 utilizing a dedicated device, such as the processor 212 owned by the data center 100/application center 24. In response to the request, the data center 100/application center 24 retrieves the user-selected preferences from the user profile, and sends the user-selected preferences to the third party facility 200, 200′, 200″.

In an example, the goods/services desired by the vehicle 12 may require vehicle data (e.g., odometer reading, fuel level, oil life, etc.), and the third party facility 200, 200′, 200″ may request such vehicle data from the data center 100/application center 24. In response to the request, the data center 100/application center 24 may establish a connection with the telematics unit 14, and request the vehicle data from the telematics unit 14. The telematics unit 14 pulls the desired information from the pertinent vehicle systems, and sends the vehicle data back to the data center 100/application center 24 during a vehicle data upload (VDU) event. The data center 100/application center 24 thereafter sends the vehicle data to the third party facility 200, 200′, 200″.

As an illustrative example, if the third party facility is fast food restaurant A (an example of the facility 200′ that includes a drive thru line), the vehicle 12 occupant(s) may submit, in response to the facility's 200, 200′, 200″ order request, his/her/their order of two sandwiches, and a large diet soft drink. The clerk 218 receiving the order may refer to the notification message to determine if any preferences are available pertaining to the order of vehicle 12, and if not, will submit a request to the data center 100/application center 24 for the preferences. If, for instance, the notification message states, or the data center 100/application center 24 sends the user-selected preferences that indicate that ketchup should be provided to the vehicle 12, the clerk 218 will notify the vehicle 12 occupant(s) during the direct or indirect connection with the vehicle 12 that he/she will put ketchup in the bag.

After the order has been submitted by the vehicle 12 occupant(s), and has been accepted by the clerk 218, the clerk 218 will query the processor 212 of the server 206 for any payment information of the subscriber vehicle 12 that is stored in the memory 214. In some instances, the server 206 (via memory 214) may contain all of the subscriber vehicle information on file. In these instances, the information may be uploaded to the server 206 from the data center 100/application center 24 each time a new subscriber signs up for the third party facility transaction service. In these instances, the clerk 218 may simply ask whether the vehicle occupant wishes to pay with his/her stored payment information. If no payment information is on file, the clerk 218 may then submit a request to the data center 100/application center 24 (using a direct connection established between the two) for payment information of the subscriber vehicle 12. In response thereto, the data center 100/application center 24 transmits the payment information back to the third party facility 200, 200′, 200″, and the clerk 218 may utilize the payment information to complete the transaction with the vehicle 12. When no information is on file, it is to be understood that the data center 100/application center 24 may send payment information to the third party facility 200, 200′, 200″ each time the third party facility 200, 200′, 200″ and the vehicle 12 interact. The data center 100 may also broker the transaction between the entities 12, 200. If the user has an account at the third party facility 200, 200′, 200″, the data center 100 may simply send a customer identifier that is associated with the vehicle's account at the third party facility, and then the third party facility may utilize the identifier to look up the account and any associated payment information.

The payment information received by the third party facility 200, 200′, 200″ may be sufficient to pay for the goods/services received by the vehicle 12. If so, then the third party facility transaction is considered to be complete. In instances where the payment information may be insufficient to pay for the goods/services, then the clerk 218 will notify the vehicle 12 occupant(s) of the same, and the vehicle 12 occupant(s) will have to tender any deficient amounts to the third party facility 200, 200′, 200″ to complete the transaction.

The payment information may be used for any goods and/or services provided to the vehicle 12 by the third party facility 200, 200′, 200″ that require some form of payment. It is to be understood that payment information is not required in instances where goods and/or services are provided to the vehicle 12 that are free of charge (such as advertisements or coupons provided by a car dealership, etc.).

The examples of the method have been described above utilizing a Wi-Fi™ connection established between the telematics unit 14 and the communications device 202. It is to be understood that the examples of the method may also be practiced utilizing BLUETOOTH® connections, as mentioned above.

While several examples have been described in detail, it will be apparent to those skilled in the art that the disclosed examples may be modified. Therefore, the foregoing description is to be considered non-limiting.

1. A method for servicing a subscriber vehicle, comprising:
via a telematics unit of the subscriber vehicle, establishing a connection with a communications device at a third party facility;
during the connection, authenticating the telematics unit of the subscriber vehicle so that the telematics unit is allowed to access a network of the third party facility;
sending a packet data message from the authenticated telematics unit of the subscriber vehicle to a telematics service center utilizing the network of the third party facility, the packet data message including an internet protocol address of the third party facility and identification information of the subscriber vehicle;
identifying the subscriber vehicle from the identification information included in the packet data message, the identifying being accomplished via a processor operatively associated with the telematics service center, the processor executing computer readable code encoded on a non-transitory, tangible computer readable medium;
identifying, via the processor, the third party facility from the internet protocol address included in the packet data message;
upon identifying the third party facility, via the telematics service center, establishing a direct connection between the telematics service center and the third party facility;
sending a notification message from the telematics service center to the third party facility via the direct connection established therebetween, the notification message indicating that the subscriber vehicle is available for servicing; and
upon receiving the notification message from the telematics service center, via the third party facility, communicating with the telematics unit of the subscriber vehicle for servicing.

2. The method as defined in claim 1 wherein the telematics unit of the subscriber vehicle includes an identification code associated with a wireless access point, the identification code being previously approved to enable the telematics unit to establish the connection with the communications device defining the wireless access point.

3. The method as defined in claim 1 wherein the packet data message further includes GPS location data of the subscriber vehicle, user-selected preferences, or combinations thereof.

4. The method as defined in claim 1 wherein during the communicating, the method further comprises:
servicing, via the third party facility, the subscriber vehicle upon receiving the notification message, wherein the servicing of the subscriber vehicle includes:
requesting user-selected preferences from the telematics service center, the requesting being accomplished utilizing a connection established directly between the third party facility and the telematics service center; and
receiving, at the third party facility, the user-selected preferences to assist with the servicing of the subscriber vehicle.

5. The method as defined in claim 4 wherein in response to the requesting of the user-selected preferences from the telematics service center, the method further comprises retrieving the user-selected preferences from a user profile stored in a database at the telematics service center.

6. The method as defined in claim 4 wherein prior to servicing the subscriber vehicle, the method further comprises designating, in a user profile stored in a database at the telematics service center, the user-selected preferences pertaining to the servicing of the subscriber vehicle, the designating being accomplished through any of a remotely accessible page, a voice connection with the telematics service center, or an electronic mailing message.

7. The method as defined in claim 1 wherein during the communicating, the method further comprises:
servicing, via the third party facility, the subscriber vehicle upon receiving the notification message;
requesting payment for the servicing of the subscriber vehicle from the telematics service center, the requesting being accomplished utilizing an other direct connection established between the third party facility and the telematics service center; and
receiving, at the third party facility, payment for the servicing from the telematics service center based on payment information previously stored in a subscriber profile stored in a database at the telematics service center.

8. The method as defined in claim 1 wherein prior to establishing the connection with the communications device, the method further comprises determining a wireless connection range from the communications device based on a type of service that is available from the third party facility.

9. (canceled)

10. The method as defined in claim 1 wherein during the communicating, the method further comprises servicing, via the third party facility, the subscriber vehicle upon receiving the notification message, wherein the servicing of the subscriber vehicle includes interacting with a vehicle occupant inside the subscriber vehicle utilizing any of a display, a touch screen, or an in-vehicle audio system.

11. The method as defined in claim 1 wherein the communications device defines a wireless access point, and wherein the connection is a short range wireless connection.

12. The method as defined in claim 1 wherein the connection is a short range wireless connection established between the telematics unit paired with the communications device.

13. A system for servicing a subscriber vehicle, comprising:
a third party facility to service the subscriber vehicle;
a wireless access point at the third party facility and defined by a communications device to which a telematics unit of a subscriber vehicle establishes a connection;
an internet protocol address of the third party facility;
a network of the third party facility, the network being i) accessible by the telematics unit of the subscriber vehicle after authentication and ii) usable by the authenticated telematics unit to transmit data to a telematics service center;
a packet data message to be sent from the authenticated telematics unit to the telematics service center, the packet data message including the data which contains identification information of the subscriber vehicle and the internet protocol address of the third party facility;
the telematics service center to receive the packet data message from the authenticated telematics unit, and to identify i) the third party facility from the internet protocol address and ii) the subscriber vehicle from the identification information of the subscriber vehicle;
a communications module at the telematics service center to establish a direct connection between the telematics service center and the third party facility upon identifying the third party facility from the internet protocol address included in the packet data message; and
a server operatively associated with the third party facility and in selective communication with the telematics service center, the server to receive a notification message from the telematics service center during the direct connection, the notification message indicating that the subscriber vehicle is available for servicing.

14. The system as defined in claim 13 wherein the communications device defining the wireless access point is to: establish a point-to-point connection with the telematics unit; transmit the internet protocol address to the telematics service center; or combinations thereof.

15. The system as defined in claim 13, further comprising one of a virtual private network (VPN) or a wide area network (WAN) to establish an other connection between the third party facility and the telematics service center, wherein the third party facility includes processing equipment for receiving the notification message from the telematics service center utilizing the VPN or the WAN, the notification message including information notifying the third party facility that the subscriber vehicle is available for servicing.

16. The system as defined in claim 13 wherein the wireless access point has a predefined wireless connection range based on a type of service available from the third party facility.

17. A system for servicing a subscriber vehicle, comprising:
a telematics unit of the subscriber vehicle to establish a connection with a communications device defining a wireless access point at a third party facility, the telematics unit being authenticated so that the telematics unit is allowed to access a network of the third party facility;
an internet protocol address of the third party facility;
a packet data message to be transmitted from the telematics unit of the subscriber vehicle to a telematics service center utilizing the network of the third party facility, the packet data message including identification information of the subscriber vehicle and the internet protocol address of the third party facility; and
the telematics service center in selective communication with a server of the third party facility, the telematics service center including:
a processor to execute computer readable code encoded on a non-transitory, tangible computer readable medium for i) identifying the subscriber vehicle from the identification information included in the packet data message and ii) the third party facility from the internet protocol address of the third party facility; and
a communications module to establish a direct connection between the telematics service center and the third party facility, and to send a notification message to the server of the third party facility during the direct connection, the notification message indicating that the subscriber vehicle is available for service.

18. The system as defined in claim 17 wherein the telematics unit includes an identification code associated with the wireless access point, the identification code being previously approved so that the telematics unit is authorized to establish the connection with the communications device defining the wireless access point.

19. The system as defined in claim 17 wherein the telematics service center further includes a database within which a subscriber profile is stored, the subscriber profile containing subscriber information that, upon being transmitted to the third party facility, is usable by the third party facility to assist with servicing the subscriber vehicle.

20. The system as defined in claim 19 wherein the subscriber information contained in the subscriber profile includes payment information, and wherein the telematics service center utilizes the payment information to provide payment to the third party facility for a service rendered to the subscriber vehicle.

21. The method as defined in claim 1 wherein the sending of the packet data message is accomplished by:
initially sending the packet data message from the telematics unit of the subscriber vehicle using a source internet protocol address of the telematics unit;
upon traversing a network of the third party facility with the packet data message, replacing the source internet protocol address used by the packet data message with the internet protocol address of the third party facility; and then
traversing the Internet with the packet data message using the internet protocol address of the third party facility.
